(19) United States
(12) Patent Application Publication
(10) Pub. No.: US 2006/0078191 A1
(43) Pub. Date: Apr. 13, 2006

(54) Apparatus and method for detecting defect on object

(75) Inventor: Akira Matsumura, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/218,775

(22) Filed: Sep. 6, 2005

(30) Foreign Application Priority Data
Sep. 29, 2004 (JP) P2004-283004

(51) Int. Cl. G06K 9/00

(52) U.S. Cl. 382/149

(57) ABSTRACT

In a defect detection apparatus, data of an inspection image and that of a reference image are inputted from an image pickup part (3) to an operation part (50), and a differential image is thereby generated in a differential image generation part (52) and an image representing a defect inclusion area which includes a defect in an area image generation part (51) as an image which has less information on a false defect and shape of a defect than information on those in the differential image. A first evaluation part (53) performs a provisional evaluation on whether a defect candidate in an area of the differential image which corresponds to the defect inclusion area is true or false. A second evaluation part (54) determines the type of feature values to be obtained from the defect candidate in accordance with a result of provisional evaluation performed by the first evaluation part (53) to obtain the feature values of the defect candidate and performs an evaluation on whether the defect candidate is true or false on the basis of the feature values. With this construction, it is possible to detect a defect on a substrate (9) with high accuracy and high efficiency.

### BACKGROUND OF THE INVENTION

1. Field of the Invention

The present invention relates to a technique for detecting a defect on an object.

2. Description of the Background Art

Various inspection methods have been used, conventionally, in a field of inspection of pattern formed on a semiconductor substrate, a printed circuit board, a glass substrate (hereinafter, referred to as “substrate”) and the like. For example, geometric feature values of a defect candidate such as an area (i.e., the number of pixels), length of circumference, roundness, direction of principal axis and degree of flattening or feature values based on a density gradient are obtained and inputted to a checker using discriminant analysis, neural network, genetic algorithm or the like, to perform a check on whether the defect candidate is a true defect or not and detect a defect.

In a technique disclosed in Japanese Patent Application Laid Open Gazette No. 2002-22421 (Document 1), two differential images between an inspection image (an image to be inspected) and two reference images are generated, and values of pixels in the two differential images are converted into error probability values by using a standard deviation of the pixel values to generate two error probability value images. Further, a product of the values of corresponding pixels in the two error probability value images is obtained to generate a probability product image, and value of each pixel in the probability product image is compared with a predetermined threshold value to determine whether there is a defect or not on an object.

Though it is possible, however, to obtain an area including a defect with high accuracy by obtaining the probability product image in the technique of Document 1, the shape of the area does not always correctly reflect the shape of the defect. Therefore, when geometric feature values of the area obtained from the probability product image are inputted to a checker to perform a high-level detection of a defect, it is not easy to select training data (e.g., an exemplary defect) in learning and in some cases, it is not possible to detect a defect with high accuracy. In general, an enormous amount of feature values are used for check by the checker and therefore it takes long time to perform computation.

### SUMMARY OF THE INVENTION

The present invention is intended for an apparatus for detecting a defect on an object, and it is an object of the present invention to detect a defect with high accuracy and high efficiency.

According to the present invention, the apparatus comprises an image pickup part for picking up an image of an object to acquire a grayscale inspection image, a first image generation part for generating a differential image between the inspection image and a grayscale reference image, a second image generation part for generating an image representing a defect inclusion area which includes a defect, as an image which has less information on a false defect and shape of a defect than information on those in the differential image, a first evaluation part for performing a provisional evaluation on whether a defect candidate in an area of the differential image which corresponds to the defect inclusion area is true or false, and a second evaluation part for determining at least one type of feature value which is obtained from the defect candidate in accordance with a result of provisional evaluation performed by the first evaluation part and performing an evaluation on whether the defect candidate is true or false on the basis of the feature value of the defect candidate.

Since a provisional evaluation is performed by using the image representing the defect inclusion area which includes a defect as an image which has less information on a false defect and shape of a defect than information on those in the differential image and at least one type of feature value which is used for the next-stage evaluation is determined in accordance with a result of the provisional evaluation, a defect on an object can be detected with high accuracy and high efficiency.

Preferably, the first evaluation part substantially compares a value on the basis of a standard deviation of values of pixels in the differential image with values of pixels included in the defect candidate to perform a provisional evaluation on whether the defect candidate is true or false. It is thereby possible to obtain the result of the provisional evaluation by a simple computation. More preferably, the first evaluation part substantially compares a value on the basis of the standard deviation with a value of each pixel in an area of the differential image which corresponds to the defect inclusion area to specify the defect candidate. It is thereby possible to easily specify the defect candidate.

Preferably, at least one type of feature value includes geometric feature values of a defect candidate, feature values of higher order local autocorrelations, and feature value on the basis of a density gradient.

Further preferably, the second evaluation part comprises a checker construction part for constructing a checker which outputs a check result obtained from the feature value, by learning, in order to perform a high-level evaluation on whether the defect candidate is true or false.

The present invention is also intended for a method for detecting a defect on an object.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a defect detection apparatus;

FIG. 2 is a diagram showing a constitution of a computer;

FIG. 3 is a diagram showing a functional structure implemented by the computer;

FIG. 4 is a flowchart showing an operation flow for detecting a defect on a substrate;

FIG. 5 is a graph illustrating a histogram of pixel values of an inspection image;

FIG. 6 is a graph illustrating a histogram of pixel values of a reference image;

FIG. 7 is a flowchart showing an operation flow for performing a provisional evaluation on whether a defect candidate is true or false;

FIG. 8 is a view showing a manner to specify defect candidates;

FIG. 9 is a graph illustrating a histogram of pixel values of a differential image;

FIG. 10 is a diagram showing a second evaluation part in accordance with a second preferred embodiment;

FIG. 11 is a view showing an arrangement of pixels;

FIGS. 12, 13A and 13B are views showing weighted matrixes;

FIGS. 14A and 14B are views showing other examples of weighted matrixes;

FIGS. 15A and 15B are views showing still other examples of weighted matrixes;

FIG. 16 is a view showing a defect inclusion area in a differential image; and

FIG. 17 is a view showing a two-dimensional histogram.

### DESCRIPTION OF THE PREFERRED EMBODIMENTS

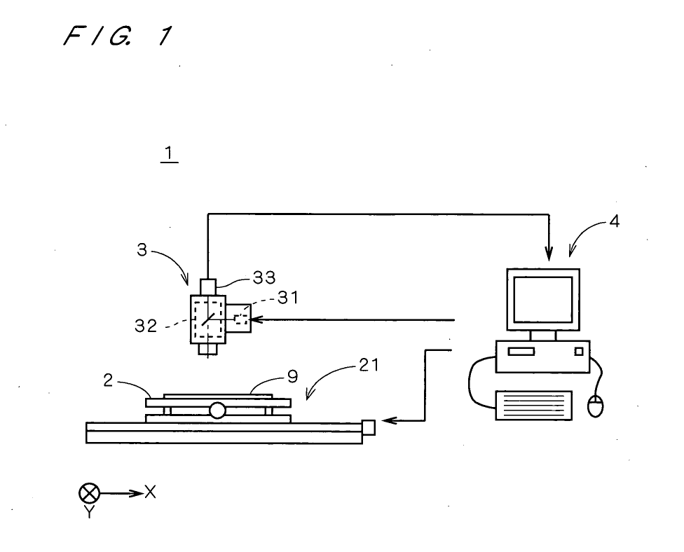

FIG. 1 is a view showing a construction of a defect detection apparatus 1 in accordance with the first preferred embodiment of the present invention. The defect detection apparatus 1 comprises a stage 2 for holding a semiconductor substrate (hereinafter, referred to as “substrate”) 9 on which a predetermined wiring pattern is formed, an image pickup part 3 for picking up an image of the substrate 9 to acquire a grayscale image of the substrate 9, a stage driving part 21 for moving the stage 2 relatively to the image pickup part 3, and a computer 4 constituted of a CPU for performing various computations, a memory for storing various pieces of information and the like. The computer 4 controls these constituent elements of the defect detection apparatus 1.

The image pickup part 3 has a lighting part 31 for emitting an illumination light, an optical system 32 which guides the illumination light to the substrate 9 and receives the light from the substrate 9 and an image pickup device 33 for converting an image of the substrate 9 formed by the optical system 32 into an electrical signal, and the image pickup device 33 outputs image data of the substrate 9. The stage driving part 21 has mechanisms for moving the stage 2 in the X direction and the Y direction of FIG. 1. Though the image is acquired by the image pickup part 3 with the illumination light which is a visible light in the first preferred embodiment, for example, an electron beam, an ultraviolet ray, an X-ray or the like may be used to acquire images.

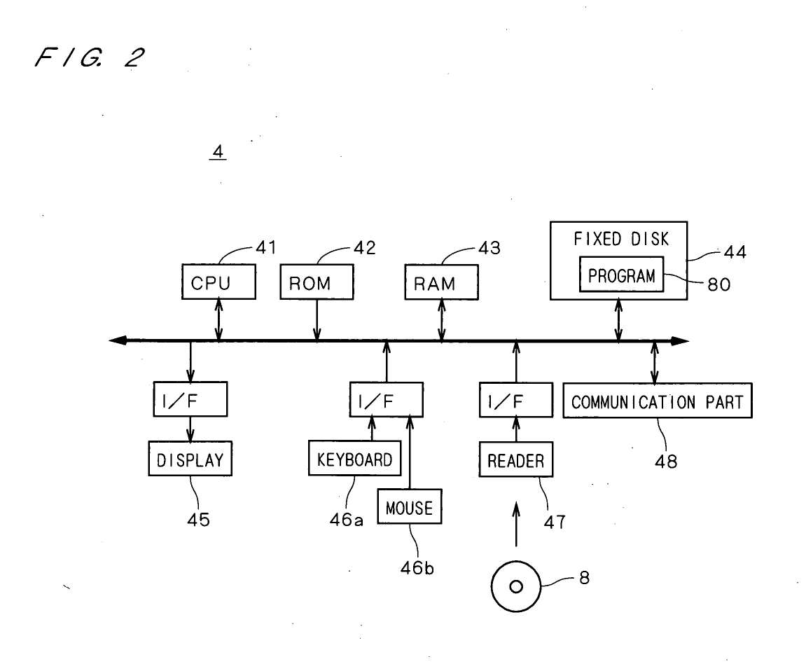

FIG. 2 is a diagram showing a constitution of the computer 4. The computer 4 has a constitution of general computer system, as shown in FIG. 2, where a CPU 41 for performing various computations, a ROM 42 for storing a basic program and a RAM 43 for storing various information are connected to a bus line. To the bus line, a fixed disk 44 for storing information, a display 45 for displaying various information such as images, a keyboard 46a and a mouse 46b for receiving an input from an operator, a reader 47 for reading information from a computer-readable recording medium 8 such as an optical disk, a magnetic disk, a magneto-optic disk, and a communication part 48 for transmitting and receiving a signal to/from other constituent elements in the defect detection apparatus 1 are further connected through an interface (I/F), and so on, as appropriate.

A program 80 is read out from the recording medium 8 through the reader 47 into the computer 4 and stored into the fixed disk 44 in advance. The program 80 is copied to the RAM 43 and the CPU 41 executes computation in accordance with the program stored in the RAM 43 (in other words, the computer 4 executes the program), and the computer 4 thereby serves as an operation part in the defect detection apparatus 1.

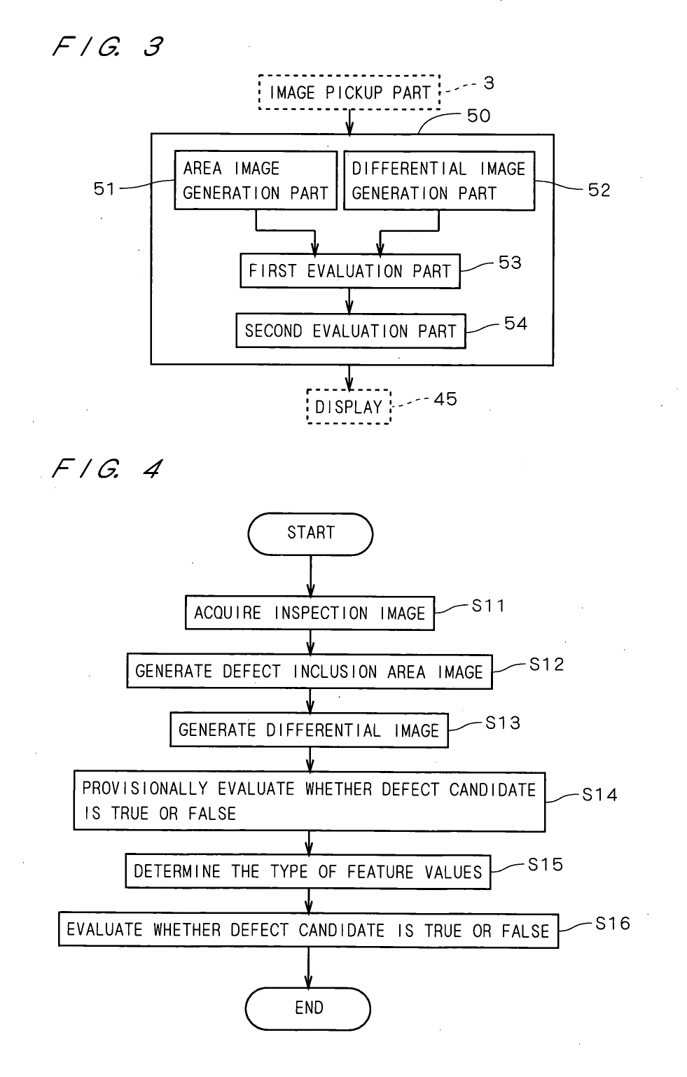

FIG. 3 is a diagram showing a functional structure implemented by the CPU 41, the ROM 42, the RAM 43, the fixed disk 44 and the like through the operation by the CPU 41 in accordance with the program 80. FIG. 3 shows functions of constituent elements of an operation part 50 (an area image generation part 51, a differential image generation part 52, a first evaluation part 53 and a second evaluation part 54) implemented by the CPU 41 and the like. These functions of the operation part 50 may be implemented by dedicated electric circuits, or may be partially implemented by the electric circuits.

FIG. 4 is a flowchart showing an operation flow of the defect detection apparatus 1 for detecting a defect on the substrate 9. In the defect detection apparatus 1, first, a predetermined inspection area (hereinafter, referred to as “a first inspection area”) on the substrate 9 is moved to an image pickup position of image pickup part 3 by the stage driving part 21 and an image of the first inspection area is acquired. Subsequently, a second inspection area which is located on the substrate 9, away from the first inspection area by a predetermined distance (for example, a distance between centers of dies arranged on the substrate 9) and a third inspection area away from the second inspection area by the same distance are sequentially adjusted to the image pickup position and images of the second inspection area and the third inspection area are thereby acquired (Step S11). In the first inspection area and the third inspection area on the substrate 9, the same pattern as that in the second inspection area is formed, and in the following operation, the image of the second inspection area serves as an inspection image (an image to be inspected) and the images of the first inspection area and the third inspection area serve as reference images. One inspection image and two reference images which are acquired thus are outputted to the operation part 50. An image which can be acquired in advance by picking up an image of a substrate with no defect or an image which can be obtained from design data may be prepared as a reference image.

FIG. 5 is a graph illustrating a histogram 61 of pixel values of the inspection image, and FIG. 6 is a graph illustrating a histogram 62 of pixel values of one of the reference images. As shown in FIGS. 5 and 6, in the defect detection apparatus 1, the inspection image and the reference images are acquired each as an image of 256 tones. The inspection image and the reference images may be each an image of multitone other than 256 tones.

The area image generation part 51 generates a defect inclusion area image representing areas (or an area) each of which includes defects (or a defect) on the substrate 9 (hereinafter, referred to as “defect inclusion area”) from the one inspection image and the two reference images (Step S12). As a process for generating the defect inclusion area image, for example, the method disclosed in the above Japanese Patent Application Laid Open Gazette No. 2002-22421 can be used and the disclosure of which is herein incorporated by reference. In this case, first, a first image representing the difference between the inspection image and the reference image of the first inspection area and a second image representing the difference between the inspection image and the reference image of the third inspection area are generated. Subsequently, a standard deviation of values of pixels of the first image is obtained, and a first error probability value image is generated by dividing the value of each pixel of the first image by the standard deviation. Similarly, a standard deviation of values of pixels of the second image is obtained, and a second error probability value image is generated by dividing the value of each pixel of the second image by the standard deviation.

After the two error probability value images are generated, one probability product image is generated by obtaining the square root of a product of value of each pixel in the first error probability value image and value of the corresponding pixel in the second error probability value image. Then, the probability product image is binarized with a predetermined threshold value and the binarized probability product image is dilated, to generate a defect inclusion area image representing defect inclusion areas including defects.

On the other hand, in the differential image generation part 52, an average value μo and a standard deviation σo of values of pixels in the inspection image are obtained and the value Xo of each pixel in the inspection image is converted into a value Zo on the basis of Eq. 1 by using the average value μo and the standard deviation σo (in other words, “standardization” (Z conversion) is performed).

$$Zo = \frac{Xo - μ o}{σ o} \qquad Eq . 1$$

For one of the two reference images, similarly, an average value μr and a standard deviation σr of values of pixels are obtained and the value Xr of each pixel in the reference image is converted into a value Zr on the basis of Eq. 2 by using the average value μr and the standard deviation σr.

$$Zr = \frac{Xr - μ r}{σ r} \qquad Eq . 2$$

In general, though the standardization like Eqs. 1 and 2 is executed for normal distribution, the histogram 61 of the pixel values in the inspection image of FIG. 5 and the histogram 62 of the pixel values in the reference image of FIG. 6 are very similar to each other and therefore these images are corrected to be contrasted with each other by using the standardization for uniform expansion and contraction of the pixel values in the histograms 61 and 62 and parallel displacement of the histograms 61 and 62.

Then, the differential image generation part 52 generates a differential image between the converted inspection image and the converted reference image (Step S13). There may be a case where another reference image is generated by calculation of the average value of values of the corresponding pixels in the two reference images, or the like, and then standardized to be used for generation of a differential image.

Herein, discussion will be made on the difference between the defect inclusion area image and the differential image. In the differential image generated in Step S13, in some cases, noises in the inspection image and the reference image increase the value of pixel at a position corresponding to a normal (non-defective) area on the substrate 9 and this may cause a false defect (pseudo defect). In contrast to this, since the defect inclusion area image is obtained from the two error probability value images as discussed above, this is an image which has less information on a false defect than that in the differential image generated by the differential image generation part 52 (in other words, an image in which a large noise is removed).

The area image generation part 51 further performs a dilation on the binarized probability product image so that a plurality of adjacent defects should be included in one defect inclusion area. Therefore, the defect inclusion area has a tendency to become larger than an original shape of the defect, and if a plurality of adjacent defects constituting one defect inclusion area includes a false defect, the shape of a genuine defect is largely different from that of the defect inclusion area. And the defect inclusion area image is generated by using two error probability value images. In consequence, the defect inclusion area image has less information on a false defect(s) and geometric shape of a defect(s) than information on those in the differential image.

After the defect inclusion area image and the differential image are generated, the first evaluation part 53 specifies each of defect candidates as a group of pixels in areas of the differential image which corresponds to the defect inclusion areas of the defect inclusion area image. After that, a provisional evaluation for each of defect candidates is performed, specifically, whether the defect candidate is a true defect or false detection is determined (Step S14). There is a case where any defect is hardly found in the differential image and no defect candidate is specified, and in such a case, the defect inclusion area itself may be specified as a defect candidate. The operation performed by the first evaluation part 53 in the Step S14 will be discussed in detail after overall discussion on a defect detection procedure.

In the second evaluation part 54, for the defect candidate specified by the first evaluation part 53 and determined as a true defect (real defect) in the provisional evaluation, the geometric feature values (e.g., roundness, area (i.e., the number of pixels), length of circumference, diameter, degree of flattening, position or direction of principal axis) of the defect candidate (or a group of pixels constituting the defect candidate) are determined as the type of feature values to be obtained (Step S15). Then, the geometric feature values of this defect candidate are obtained, and in the case where the defect candidate is specified to be in parallel with a direction in which a pattern extends and exists on an edge of the pattern on the basis of the geometric feature values or the case where the defect candidate is specified to be a perfect circle having a small diameter which exists near the center of a pattern on the substrate 9, this defect candidate is evaluated as false detection or a non-problematic true defect (which can be regarded as false detection) and otherwise evaluated as a true defect (Step S16).

For the defect candidate which is evaluated as false detection as the result of the provisional evaluation, feature values of higher order local autocorrelations (HLAC), for example, are determined as the type of feature values to be obtained (Step S15), and the feature values (which are expressed as a vector) of higher order local autocorrelations of respective areas in the inspection image and the reference image (e.g., the reference image used for generation of the differential image) which correspond to the defect inclusion area are obtained. Then, if the difference between the feature values of higher order local autocorrelations of the inspection image and those of the reference image is not smaller than a predetermined threshold value, the defect candidate included in the defect inclusion area (an area corresponding thereto) is evaluated as a true defect (or a possible defect) and otherwise evaluated as false detection (Step S16).

Thus, the second evaluation part 54 determines the type(s) of feature values (or a value) to be obtained from the defect candidate in accordance with the result of the provisional evaluation performed by the first evaluation part 53 and performs an evaluation on whether the defect candidate is true or false on the basis of the feature values. It is therefore possible to reevaluate a defect candidate which is a true defect but evaluated as false detection in the provisional evaluation by the first evaluation part 53, as a true defect by using an appropriate type of feature values or reevaluate a defect candidate which is false detection but evaluated as a true defect in the provisional evaluation, as false detection by using an appropriate type of feature values. The result of evaluation by the second evaluation part 54 is displayed on the display 45 and the defect on the substrate 9 is reported to an operator, and the above operations (Steps S11 to S16) are repeated for the next inspection area on the substrate 9.

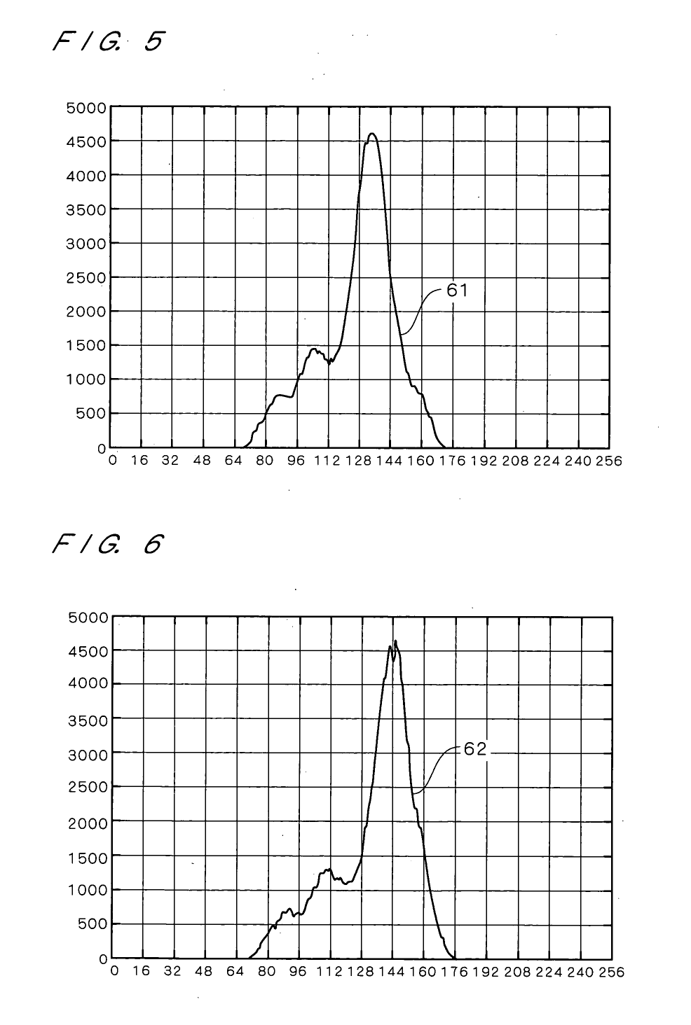

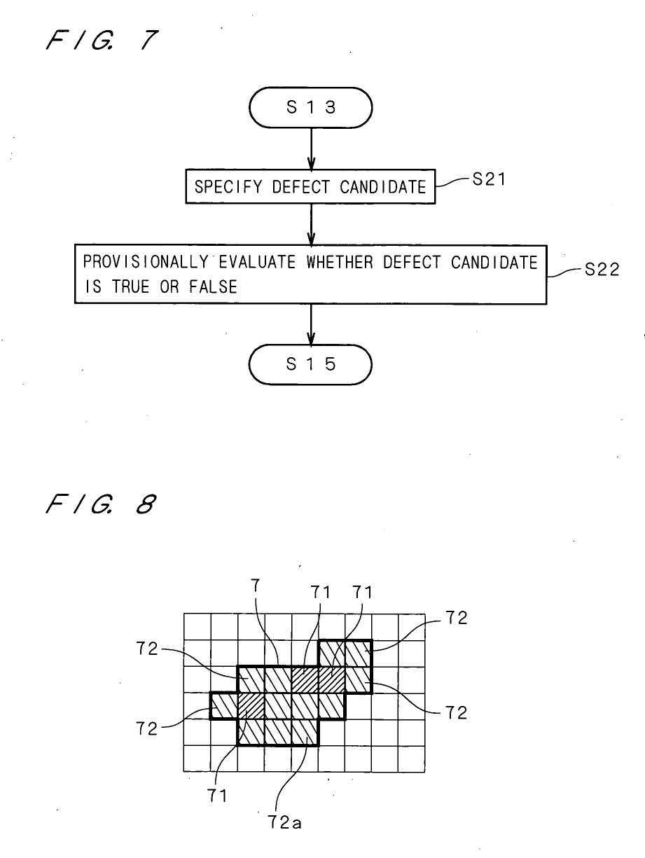

Next, the operation of the first evaluation part 53 in Step S14 of FIG. 4 will be discussed. FIG. 7 is a flowchart showing an operation flow of the first evaluation part 53 for performing a provisional evaluation on whether a defect candidate is true or false. After the differential image is generated by the differential image generation part 52 (FIG. 4: Step S13), the first evaluation part 53 obtains an average value μd and a standard deviation σd of values of pixels in the differential image and a converted value Zd is obtained by dividing the difference between a value Xd of each pixel in the differential image and the average value μd by the standard deviation σd, as shown in Eq. 3.

$$Zd = \frac{X ⅆ - μ ⅆ}{σ ⅆ } \qquad Eq . 3$$

Then, pixels whose absolute value of the value Zd in the converted differential image is larger than the predetermined threshold value, i.e., a defect candidate pixel threshold value of 3 are specified and some of the pixels which exist in the defect inclusion area (hereinafter, referred to as “defect candidate pixels”) are further specified. In other words, in the defect inclusion area of the unconverted differential image, a pixel having a value Xd is determined as the defect candidate pixel, where an absolute value of difference between the value Xd and the average value μd is larger than a value obtained by multiplying the standard deviation σd by the defect candidate pixel threshold value (i.e., 3).

Subsequently, pixels in the converted differential image, whose absolute value of the value Zd is larger than a predetermined quasi-defect candidate pixel threshold value of 2.5, (hereinafter, referred to as “quasi-defect candidate pixels”) are specified (except the defect candidate pixels). Then, some of the quasi-defect candidate pixel which are in 8-connected neighborhoods of the defect candidate pixels are further specified, and as shown in FIG. 8, defect candidate pixels 71 and quasi-defect candidate pixels 72 are connected with one another. At this time, the defect candidate pixels 71 which are in 8-connected neighborhoods of each other and the quasi-defect candidate pixel(s) 72a which is in 8-connected neighborhoods of the quasi-defect candidate pixel 72 connected with the defect candidate pixel 71 is also connected with one another, and a group of pixels which are connected with one another is determined as a defect candidate 7 (Step S21). Thus, the first evaluation part 53 easily specifies the defect candidate 7 by substantially comparing the value on the basis of the standard deviation of values of pixels of the differential image with the difference between each of the values of pixels and the average value in the area of the unconverted differential image which corresponds to the defect inclusion area.

After the defect candidate 7 is specified, in the converted differential image, the sum of the absolute values of values of pixels included in the defect candidate 7 (hereinafter, referred to as “evaluation value”) is obtained (in other words, Σabs(Zd) is obtained, where abs(Zd) represents an absolute value of the Zd and Zd represents a value of each of pixels included in the defect candidate 7).

Then, the provisional evaluation on whether the defect candidate 7 is true or false is performed, where the evaluation value of each the defect candidate 7 is compared with the defect evaluation threshold value of 6 (Step S22). In the defect candidate 7 consisting of one defect candidate pixel 71 and two quasi-defect candidate pixels 72 which are connected with one another, for example, since the evaluation value is larger than the defect evaluation threshold value of 6, the defect candidate 7 is provisionally evaluated to be a true defect. In the defect candidate 7 consisting of one defect candidate pixel 71 and one quasi-defect candidate pixel 72 which are connected with one another, since the evaluation value is not larger than the defect evaluation threshold value of 6 depending on the value of the defect candidate pixel 71, in this case, the defect candidate 7 is provisionally evaluated to be false detection.

Thus, in the first evaluation part 53, the provisional evaluation on whether the defect candidate 7 is true or false is performed by comparing the sum of the absolute values of values of pixels included in the defect candidate 7 with a predetermined threshold value in the differential image converted on the basis of the standard deviation of the values of pixels. As a result, it is possible to obtain the result of the provisional evaluation by simple calculation, without using a lot of geometric feature values or the like. The above operation is substantially the same as the provisional evaluation on whether the defect candidate 7 is true or false by comparing the sum of the absolute values of differences between the values of the pixels included in the defect candidate 7 and the average value with a threshold value on the basis of the standard deviation of the values of pixels in the unconverted differential image. The result of the provisional evaluation obtained by the first evaluation part 53 is outputted to the second evaluation part 54 and used for the evaluation on whether the defect candidate 7 is true or false (FIG. 4: Step S15). In the first evaluation part 53, with respect to a defect inclusion area in which no defect candidate 7 is specified, the area itself may be provisionally evaluated to be false detection.

Herein, the defect evaluation threshold value, the defect candidate pixel threshold value and the quasi-defect candidate pixel threshold value will be discussed. FIG. 9 is a graph illustrating a histogram 63 of pixel values of a differential image. The histogram 63 of FIG. 9 is a histogram of the pixel values obtained by adding 128 to the value of each pixel in a differential image generated without conversion, using Eq. 1 or 2, of the inspection image and the reference image for which the histogram 61 of FIG. 5 and the histogram 62 of FIG. 6 are created, respectively.

In general, since the ratio of defects to the whole inspection image is negligible, the shapes of the histogram 61 of values of pixels in an inspection image and the histogram 62 of pixel values in a reference image are similar to each other as shown in FIGS. 5 and 6, and in this case, the width of the histogram 63 of pixel values in a differential image which is generated from the inspection image and the reference image depends on random noise. Assuming that the histogram 63 of the pixel values in the differential image follows a normal distribution, in the differential image, if an absolute value of difference between a value and an average value of the values of pixels therein is larger than three times a standard deviation, a pixel having the value (i.e., a defect candidate pixel) is an abnormal pixel with probability of 99.74% (3 sigma rule), and on the basis of this, the defect candidate pixel threshold value is determined to be 3 in the present preferred embodiment.

In a differential image having 48 by 48 (=2304) pixels, for example, however, even if no defect actually exists, six defect candidate pixels (in other words, pixels of false defects) probabilistically exist. The probability that two of the six pixels of false defects are in an 8-connected neighborhood is 2.5% from the Monte Carlo method, which is practically negligible. Then, in the present preferred embodiment, the defect evaluation threshold value is determined to be 6.

Actually, not only in the case where the defect candidate pixels are in 8-connected neighborhoods of one another but also in the case where several pixels which are considered to be abnormal pixels with relatively high probability (quasi-defect candidate pixels) are in 8-connected neighborhoods of the defect candidate pixel, this group of pixels is regarded as a defect candidate. Then, if an absolute value of difference between a value and an average value of values of pixels is larger than 2.57 times a standard deviation, a pixel having the value is an abnormal pixel with probability of 99%, and for simple calculation, the quasi-defect candidate pixel threshold value is determined to be 2.5 in the present preferred embodiment. The defect evaluation threshold value, the defect candidate pixel threshold value and the quasi-defect candidate pixel threshold value can be determined as appropriate in accordance with the probability of occurrence of false defect and are not limited to the above values. In specifying a defect candidate, a value with which values of the pixels in the defect inclusion area of the differential image is compared has only to be substantially based on a standard deviation.

Table 1 shows an exemplary result of a provisional evaluation performed by the first evaluation part 53, where comparison is made between the result of provisional evaluation by the first evaluation part 53 and the result of human check on whether 94 defect candidates included in a plurality of inspection images each having 48 by 48 pixels are true or false. The human check is performed by picking up an image of an actual substrate 9 with a scanning electron microscope (SEM).

TABLE 1

Provisional Evaluation Result

| Human Check Result | False Detection | True Defect |
|---|---|---|
| False Detection | 46 | 19 |
| True Defect | 3 | 26 |

From Table 1, the ratio of defect candidates on which the result of the provisional evaluation agrees with the result of human check (ratio of correct answers) is 76.6 (%) (=(46+26)/94×100). In fact, since the three defect candidates which are evaluated as false detection in the provisional evaluation by the first evaluation part 53 though judged to be true defects by human are not included in the defect inclusion area of the defect inclusion area image generated by the area image generation part 51, the ratio of correct answers obtained only by the first evaluation part 53 is 79.1 (%) (=(46+26)/91×100). In the case where an evaluation on whether the defect candidates are true or false is performed by discriminant analysis or the like, using an enormous amount of feature values, in general, the ratio of correct answers is 86 to 88 (%), practical result for the provisional evaluation (in other words, for rough discrimination) can be obtained by the first evaluation part 53.

Thus, in the defect detection apparatus 1, the first evaluation part 53 performs a provisional evaluation on whether each of defect candidates in the areas of the differential image between the inspection image and the reference image, which corresponds to the defect inclusion areas, is true or false, and the second evaluation part 54 determines at least one appropriate type of feature values for each defect candidate on the basis of the result of the provisional evaluation performed by the first evaluation part 53 and performs an evaluation on whether the defect candidate is true or false. The defect detection apparatus 1 can thereby detect a defect on the substrate 9 with high accuracy and high efficiency, through layered operations for detecting a defect. Since the first evaluation part 53 performs the provisional evaluation on whether the defect candidate is true or false by substantially comparing the value on the basis of the standard deviation of the values of pixels in the differential image with values of the pixels included in the defect candidate, it is possible to easily obtain a result of the provisional evaluation.

In the second evaluation part 54, since the types of feature values to be obtained include the geometric feature values, it is possible to evaluate whether the specified defect candidate is true or false by using the geometric feature values with high accuracy. Since the types of feature values to be obtained further include feature values of the higher order local autocorrelations, even for a defect candidate which is hard to detect because the value of its pixel can not be large in the differential image (e.g., a defect having a large area (i.e., the number of pixels)) and the like, it is possible to perform a higher-level evaluation by using feature values of the higher order local autocorrelations.

In the defect detection apparatus 1, the first evaluation part 53 may obtain a result of the provisional evaluation in which the discrimination between the true defect and the false detection is not clear. For example, it is provisionally evaluated that the defect candidate whose evaluation value is smaller than 4 should be false detection with almost no mistake, the defect candidate whose evaluation value is not smaller than 4 and not larger than 6 should be uncertain about whether true or false, which is not determined as a true defect or false detection, and the defect candidate whose evaluation value is larger than 6 should be a true defect with almost no mistake.

For the defect candidate which is provisionally evaluated to be uncertain about whether true or false, the Euler Number in an area of an image obtained by binarizing the error probability value image generated by the area image generation part 51 with a predetermined threshold value, which corresponds to the defect inclusion area, is determined as the type of feature value to be obtained, and then the feature value is obtained (FIG. 4: Step S15). For the defect candidate which is provisionally evaluated as false detection with almost no mistake and the defect candidate which is provisionally evaluated as a true defect with almost no mistake, feature values of the higher order local autocorrelations and the geometric feature values are determined as the types of feature values to be obtained, respectively.

The Euler Number which is obtained for the defect candidate which is provisionally evaluated to be uncertain about whether true or false is compared with a predetermined upper threshold value and a predetermined lower threshold value. Specifically, if the Euler Number is larger than the upper threshold value, this means the number of connected components in the defect inclusion area (or an area corresponding thereto) of the binarized error probability value image is sufficiently larger than the number of holes (for example, the connected components are distributed entirely in the area like grains), and if the Euler Number is smaller than the lower threshold value, this means the number of holes in the defect inclusion area of the binarized error probability value image is sufficiently larger than the number of connected components (for example, the holes are distributed entirely in the area like mesh), and therefore it is thought that the area is regarded as the defect inclusion area due to an influence of noise or the like by the area image generation part 51 and the defect candidate is determined to be false detection in both cases.

If the Euler Number is smaller than the upper threshold value and larger than the lower threshold value, the geometric feature values of each connected component in the defect inclusion area of the binarized error probability value image are obtained and the evaluation result is obtained on the basis of the geometric feature values.

For the defect candidate which is provisionally evaluated to be uncertain about whether true or false or false detection, there may be a case where some area in the defect inclusion area is separated by a predetermined method (e.g., by binarizing the differential image) and for the separated area, the geometric feature values, for example, are obtained and the evaluation is performed on the basis of the geometric feature values. In this case, if any area can not be substantially separated, such as in a case where there are an infinite number of separated areas, the defect candidate may be evaluated as false detection.

FIG. 10 is a diagram showing a second evaluation part 54a in the defect detection apparatus 1 in accordance with the second preferred embodiment. The second evaluation part 54a of FIG. 10 has a checker 541 for outputting a check result by being inputted at least one type of feature value(s) and a checker construction part 542 for constructing the checker 541 by learning. Herein, the checker 541 uses discriminant analysis, neural network, genetic algorithm, genetic program or the like. The checker construction part 542 creates training data while learning to generate a defect check condition appropriate to the checker 541, and the generated defect check condition is inputted to the checker 541.

In the second evaluation part 54a, for example, for the defect candidate which is provisionally evaluated as false detection by the first evaluation part 53, feature values on the basis of a density gradient are determined as the type of feature values to be obtained (FIG. 4: Step S15) and these feature values are obtained and inputted to the checker 541. Then, in accordance with the defect check condition, the evaluation result on whether the defect candidate is true or false is outputted (Step S16) and reported to an operator. For the defect candidate which is provisionally evaluated as a true defect, another type of feature values are obtained.

Next, for discussion on the feature values on the basis of the density gradient, first, the density gradient of an image will be discussed. Vector Vr (x, y) representing the density gradient in coordinates (x, y) of the image defined by X direction and Y direction are expressed as Eq. 4 where values of first order differential in the X and Y directions are fx and fy, respectively.
Vr(x, y)=(fx, fy) Eq. 4

In a digital image where pixels are arranged in the X and Y directions, assuming that a value of a pixel at a position (x, y) is f(x, y), fx and fy in Eq. 4 are expressed as Eq. 5. In this case, the vector Vr is directed from the side of darker towards the side of brighter.

$$\{ \begin{matrix}fx = f ( x + 1 , y ) - f ( x , y ) \\ fy = f ( x , y + 1 ) - f ( x , y )\end{matrix} \qquad Eq . 5$$

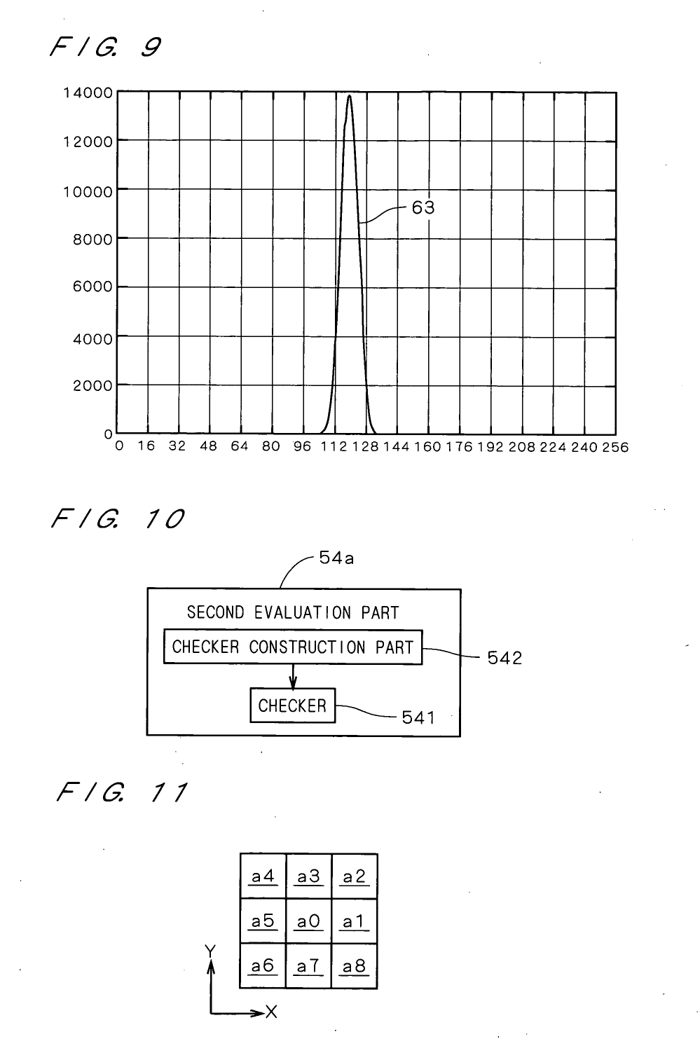

Next, discussion will be made on a method for obtaining the vector Vr (x, y) in an actual image processing. On the pixels a0 to a8 in a 3-by-3-pixel matrix shown in FIG. 11, for example, assuming that respective values of these pixels are h0 to h8, the value h0 of the central specified pixel a0 is converted into a value go by calculation of Eq. 6, using a weighted matrix having 3 by 3 elements shown in FIG. 12. In Eq. 6, n represents a value which is variable in accordance with the weighted matrix (which may be a given value) and k is an integer ranging from 0 to 8.

$$g0 = \frac{{\sum }_{k} hk \cdot wk}{n} \qquad Eq . 6$$

In Eq. 6, the converted value go is obtained by calculating the sum of values which are obtained by multiplying the values h0 to h8 of the specified pixel a0 and the pixels in its 8-connected neighborhoods, i.e., a1 to a8 by corresponding values w0 to w8 in the weighted matrix, respectively, as weights and then dividing the sum by n.

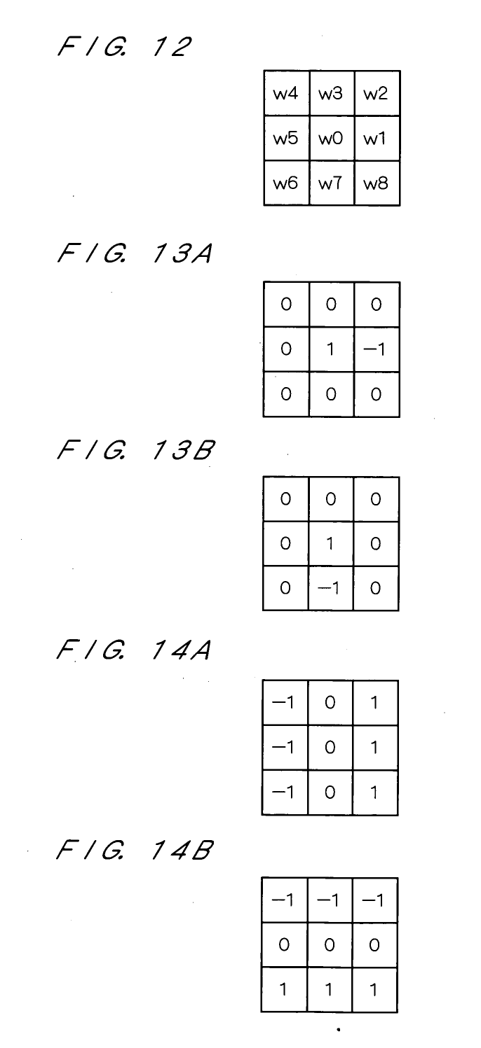

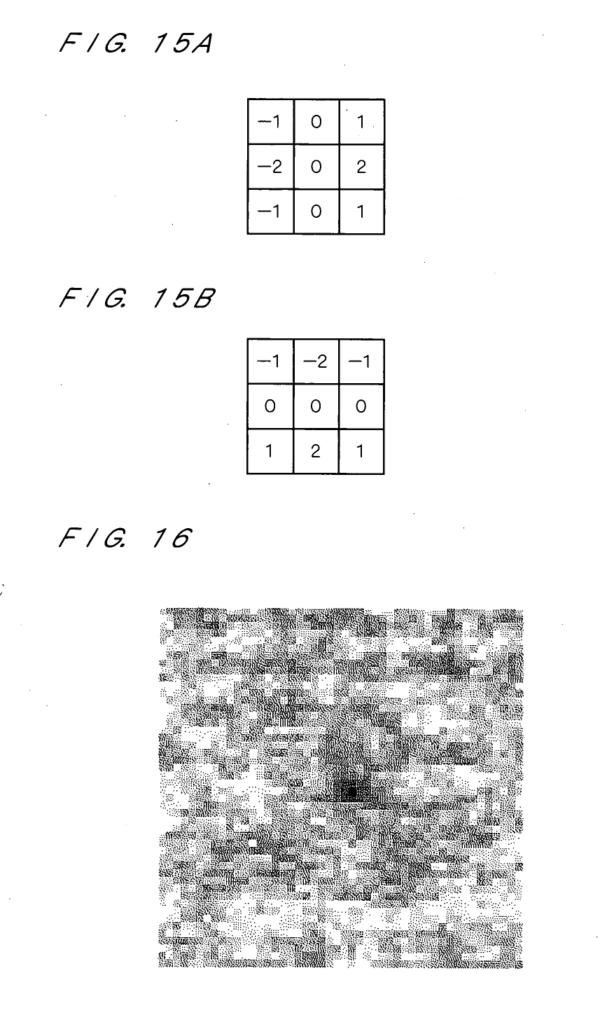

The value fx of first order differential in the X direction is approximately obtained by calculation of Eq. 6 using the matrix of FIG. 13A as the weighted matrix and the value fy of first order differential in the Y direction is approximately obtained by calculation of Eq. 6 using the matrix of FIG. 13B. The matrixes of FIGS. 13A and 13B are termed “kernel” and in these matrixes, n of Eq. 6 is usually 2. In calculation of fx and fy, other matrixes such as the matrixes of FIGS. 14A and 14B (termed “Prewitt”) and the matrixes of FIGS. 15A and 15B (termed “Sobel”) may be used.

In the second evaluation part 54a, for each pixel included in the defect inclusion area (or an area corresponding thereto) in the differential image shown in FIG. 16, fx and fy are obtained by the above method to acquire the vector Vr. Then, the length r and the direction θ of the vector Vr are obtained from Eq. 7 and Eq. 8, respectively.
r=\sqrt{fx²+f_{y}²} Eq. 7

$$θ = {tan}^{- 1} ( \frac{fy}{fx} ) \qquad Eq . 8$$

The vector Vr includes feature values representing relative variation in tone among the pixels in the defect inclusion area of the differential image, and if there is a nonlinear variation in tone depending on the condition of illumination in acquisition of the image, the vector Vr has little influence thereof.

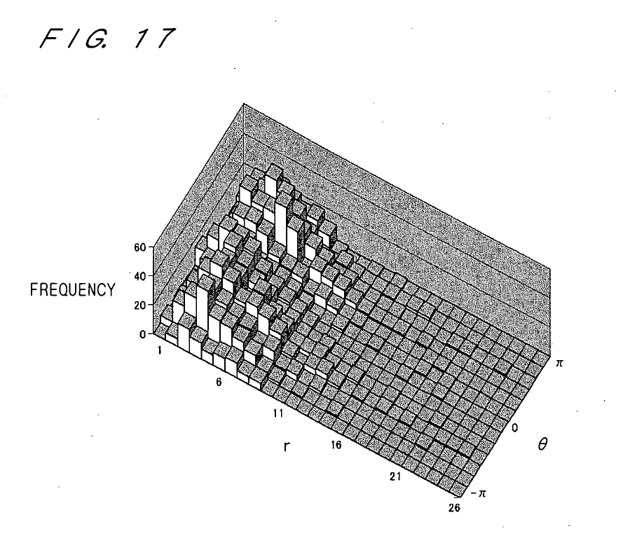

The second evaluation part 54a generates a two-dimensional histogram in a two-dimensional space with parameters of the length r and the direction θ of the vector Vr, by inputting the frequency of combinations of the length r and the direction θ of each vector Vr. In this case, in an image of 256 tones (8-bit tones) with values of pixels ranging from θ to 255, the length r of the vector Vr ranges from 0 to about 361 and the direction θ ranges from (−π) to (+π), but in the two-dimensional histogram, respective ranges of the length r and the direction θ are quantized at a desired interval. For example, in the two-dimensional histogram of FIG. 17, the length r is divided into 26 and the direction θ is divided into 13, and a vector having 338 frequencies as elements is acquired as feature values on the basis of the density gradient.

If the vectors Vr obtained for a plurality of pixels are used in the evaluation by the second evaluation part 54a as feature values, the feature values are a large amount of data in proportion to the number of pixels included in the defect inclusion area, but since the second evaluation part 54a generates the two-dimensional histogram, it is possible to acquire feature-value vectors having a small amount of data. The feature-value vectors are inputted to the checker 541 and an evaluation result in accordance with the defect check condition is outputted therefrom. The number of divided ranges of the length r and that of the direction θ may be determined as appropriate in accordance with a pattern formed on the substrate 9 or the like.

Thus, the second evaluation part 54a of FIG. 10 is provided with the checker construction part 542 for constructing the checker 541 by learning, and in the second evaluation part 54a, the type of feature values to be obtained from the defect candidate in accordance with the result of the provisional evaluation performed by the first evaluation part 53 is determined and the feature values are obtained and inputted to the checker 541. As a result, it is possible to highly evaluate whether the defect candidate is true or false with the automatically-constructed checker 541. The second evaluation part 54a can evaluate whether the defect candidate is true or false with higher accuracy by using the feature values on the basis of the density gradient. In the defect detection apparatus 1, the geometric feature values or the feature values of the higher order local autocorrelations of the defect candidate may be inputted to the checker 541 to obtain the evaluation result. A plurality of types of feature value(s) may be inputted to the checker 541.

In an ideal image with sufficiently high resolution for patterns, defects or the like on the substrate 9 and no noise, the feature-value vectors on the basis of the density gradient hardly depend on the position of the defect in the image. Even if there are a plurality of defects belonging to the same class and having the same shape and different orientations, only the position of distribution is shifted in a direction of θ axis on the two-dimensional histogram and an evaluation having little influence of rotation of the defects can be obtained, depending on the defect check condition in the checker 541.

Though the preferred embodiments of the present invention have been discussed above, the present invention is not limited to the above-discussed preferred embodiments, but allows various variations.

The image representing the defect inclusion area does not necessarily have to be generated on the basis of the probability product image but any image may be used only if it represents the defect inclusion area with less information on a false defect and shape of a defect than information on those of the differential image.

The operation flow of FIG. 4 may be changed as appropriate within the bounds of possibility. For example, though the defect inclusion area image is generated in Step S12 of FIG. 4 and thereafter the differential image is generated in Step S13 in the above preferred embodiments, either of these steps may be performed previously (naturally, may be performed at the same time) only if the defect inclusion area image and the differential image are generated prior to the provisional evaluation performed by the first evaluation part 53.

In the defect detection apparatus 1, an evaluation part may be additionally provided, for evaluating whether a defect candidate is true or false by using the evaluation result obtained by the second evaluation part 54.

The substrate 9 is not limited to a semiconductor substrate but may be a printed circuit board, a glass substrate or the like. An object whose defect is detected by the defect detection apparatus 1 may be something other than the substrate.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-283004 filed in the Japan Patent Office on Sep. 29, 2004, the entire disclosure of which is incorporated herein by reference.

What is claimed is:

1. An apparatus for detecting a defect on an object, comprising:
an image pickup part for picking up an image of an object to acquire a grayscale inspection image;
a first image generation part for generating a differential image between said inspection image and a grayscale reference image;
a second image generation part for generating an image representing a defect inclusion area which includes a defect, as an image which has less information on a false defect and shape of a defect than information on those in said differential image;
a first evaluation part for performing a provisional evaluation on whether a defect candidate in an area of said differential image which corresponds to said defect inclusion area is true or false; and
a second evaluation part for determining at least one type of feature value which is obtained from said defect candidate in accordance with a result of provisional evaluation performed by said first evaluation part and performing an evaluation on whether said defect candidate is true or false on the basis of said feature value of said defect candidate.

2. The apparatus according to claim 1, wherein
said first evaluation part substantially compares a value on the basis of a standard deviation of values of pixels in said differential image with values of pixels included in said defect candidate to perform a provisional evaluation on whether said defect candidate is true or false.

3. The apparatus according to claim 2, wherein
said first evaluation part substantially compares a value on the basis of said standard deviation with a value of each pixel in an area of said differential image which corresponds to said defect inclusion area to specify said defect candidate.

4. The apparatus according to claim 1, wherein
said at least one type of feature value includes geometric feature values of a defect candidate.

5. The apparatus according to claim 1, wherein
said at least one type of feature value includes feature values of higher order local autocorrelations.

6. The apparatus according to claim 1, wherein
said at least one type of feature value includes feature values on the basis of a density gradient.

7. The apparatus according to claim 1, wherein
said second evaluation part comprises a checker construction part for constructing a checker which outputs a check result obtained from said feature value, by learning.

8. A method for detecting a defect on an object, comprising the steps of:
a) acquiring a grayscale inspection image of an object;
b) generating a differential image between said inspection image and a grayscale reference image;
c) generating an image representing a defect inclusion area which includes a defect, as an image which has less information on a false defect and shape of a defect than information on those in said differential image;
d) performing a provisional evaluation on whether a defect candidate in an area of said differential image which corresponds to said defect inclusion area is true or false;
e) determining at least one type of feature value which is obtained from said defect candidate in accordance with a result of said provisional evaluation; and
f) obtaining said feature value of said defect candidate and performing an evaluation on whether said defect candidate is true or false on the basis of said feature value.

9. The method according to claim 8, wherein
a value on the basis of a standard deviation of values of pixels in said differential image is substantially compared with values of pixels included in said defect candidate to perform a provisional evaluation on whether said defect candidate is true or false in said step d).

10. The method according to claim 9, wherein
a value on the basis of said standard deviation is substantially compared with a value of each pixel in an area of said differential image which corresponds to said defect inclusion area to specify said defect candidate in said step d).

11. The method according to claim 8, wherein
said at least one type of feature value includes geometric feature values of a defect candidate.

12. The method according to claim 8, wherein
said at least one type of feature value includes feature values of higher order local autocorrelations.

13. The method according to claim 8, wherein
said at least one type of feature value includes feature values on the basis of a density gradient.

14. The method according to claim 8, wherein
a checker is constructed by learning, and
said feature value is inputted to said checker to perform an evaluation on whether said defect candidate is true or false in said step f).
